(19) United States
(12) Patent Application Publication
(10) Pub. No.: US 2015/0158702 A1
(43) Pub. Date: Jun. 11, 2015

(54) Low-Rise Elevator

(71) Applicant: ThyssenKrupp Elevator AG, Essen (DE)

(72) Inventors: Frank Dudde, Collierville, TN (US); Peter Feldhusen, Collierville, TN (US); William W. Delk, Olive Branch, MS (US); Jie Xu, Cordova, TN (US); Michael Palazzola, Horn Lake, MS (US)

(21) Appl. No.: 14/553,702

(22) Filed: Nov. 25, 2014

Related U.S. Application Data
(63) Continuation-in-part of application No. 14/102,429, filed on Dec. 10, 2013.

(51) Int. Cl. B66B 11/08; B66B 7/06; B66B 7/10; B66B 9/00; B66B 11/00; B66B 15/04; B66B 1/24

(52) U.S. Cl. CPC B66B 11/08; B66B 15/04; B66B 7/062; B66B 1/24; B66B 9/00; B66B 11/0005; B66B 7/10; B66B 11/008

(57) ABSTRACT

One or more drum winches rotate suspension members to raise and lower an elevator car within a hoistway. Support structures on opposite sides of the hoistway support the winch(es) or drive sheave(es). The suspension members may be configured in a dual closed loop system, a single open loop system, or a single closed loop system. The suspension members may be flat or toothed members. A synchronization device may be used to control the winch(es) or drive sheave(es) to maintain the level of the elevator car.

### PRIORITY

This application is a continuation-in-part of U.S. patent application Ser. No. 14/102,429, entitled “Low-Rise Elevator,” filed Dec. 10, 2013, the disclosure of which is incorporated by reference herein.

### FIELD

The present invention relates to elevators. More specifically, the present invention relates to main component parts of lifts in, or associated with, buildings or other structures, namely one or more driving gears with hoisting members that are positively attached to a winding drum or are driven by a drive sheave.

### BACKGROUND

In the field of elevators, it is desirable to minimize the amount of building space taken by the elevator hoistway and the equipment used to raise and lower the elevator car(s). While there may be devices and methods that attempt to accomplish this, it is believed that no one prior to the inventor(s) has made or used an invention as described herein.

### SUMMARY

In one aspect of the present disclosure, an elevator system includes one or more winches or drive sheaves where one or more suspension members connect the one or more winches or drive sheaves to an elevator car. In one aspect the one or more suspension members are flat. In another aspect the one or more suspension members are toothed or have a cog surface. In another aspect the elevator system includes a synchronization device and control system that allows independent control in systems with more than one winch or drive sheave. This device and control enables leveling of the elevator car. Such systems as disclosed herein provide cost and space efficient alternatives to traditional hydraulic elevator systems.

Other aspects, features, and techniques within the scope of the present disclosure will become more apparent to those of ordinary skill in the art from the following description taken in conjunction with the drawings.

### BRIEF DESCRIPTION OF THE DRAWINGS

It is believed that the present invention will be better understood from the following description of certain examples taken in conjunction with the accompanying drawings, in which like reference numerals identify like elements.

FIG. 1 is a schematic drawing of an elevator system according to one embodiment.

FIG. 2 is a perspective drawing of the elevator system of FIG. 1.

FIG. 3 is a schematic drawing of an elevator system according to a second embodiment.

FIG. 4 is a schematic drawing of an elevator system according to a third embodiment.

FIG. 5 is a schematic drawing of a drum winch for use with various embodiments.

FIG. 6 is a perspective view of an embodiment of a tooth belt and complementary drive sheave for use with various embodiments of an elevator system as disclosed herein.

FIG. 7 is a schematic drawing of adjacent teeth disposed on the tooth belt of FIG. 6.

FIG. 8 is a perspective view of an alternate embodiment of a tooth belt for use with various embodiments of an elevator system as disclosed herien.

FIG. 9 is a perspective view of an embodiment of a sheave for use with the tooth belt of FIG. 8.

FIG. 10 is a schematic drawing of an elevator system according to a fourth embodiment of the present disclosure.

FIG. 11 is a schematic drawing of an elevator system according to a fifth embodiment of the present disclosure.

FIG. 12 is a schematic drawing of an elevator system according to a sixth embodiment of the present disclosure.

FIG. 13 is a block diagram of a synchronization control for use with various embodiments of an elevator system of the present disclosure.

FIG. 14 is a schematic drawing of a belt having a wave protector for use with various embodiments of an elevator system of the present disclosure.

FIG. 15 is a front view of a belt having belt retainers for use with various embodiments of an elevator system of the present disclosure.

The drawings are not intended to be limiting in any way, and it is contemplated that various embodiments of the present disclosure may be carried out in a variety of other ways, including those not necessarily depicted in the drawings. The accompanying drawings incorporated in and forming a part of the specification illustrate several aspects of the present disclosure, and together with the descriptions serve to explain the principles and concepts of the present disclosure; it being understood, however, that the present disclosure is not limited to the precise arrangements shown.

### DESCRIPTION

The following description and embodiments of the present disclosure should not be used to limit the scope of the present disclosure. Other examples, features, aspects, embodiments, and advantages of the present disclosure will become apparent to those skilled in the art from the following description. As will be realized, the present disclosure may contemplate alternate embodiments than those exemplary embodiments specifically discussed herein without departing from the scope of the present disclosure. Accordingly, the drawings and descriptions should be regarded as illustrative in nature and not restrictive.

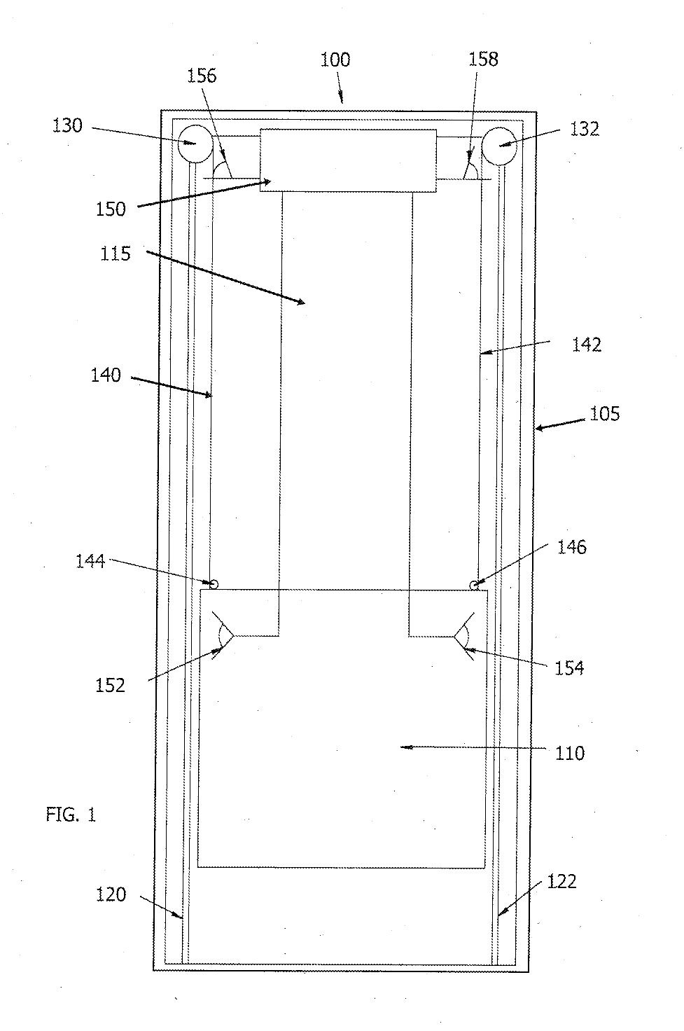

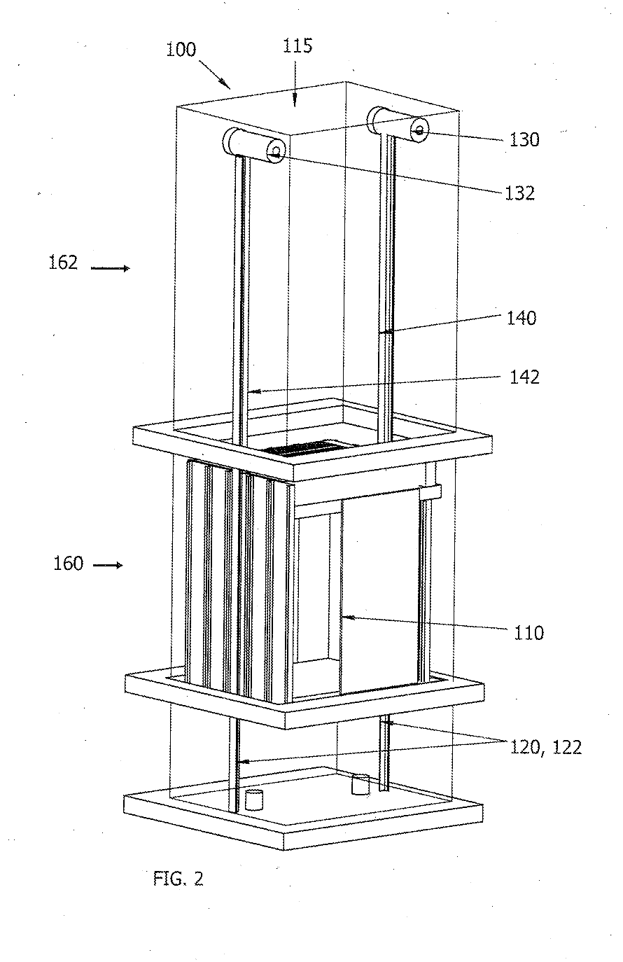

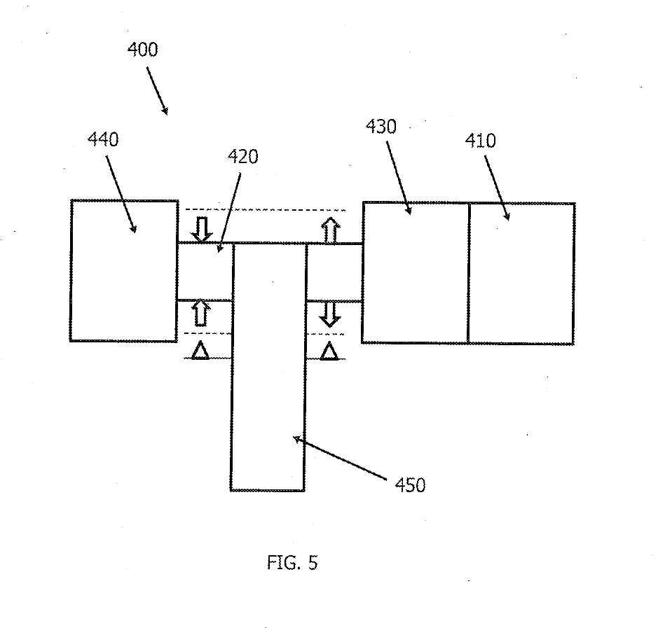

Generally, one embodiment of an elevator system of the present disclosure comprises an elevator car suspended from a flat cable that is coupled to an overhead drum winch, as illustrated in FIGS. 1-2. As shown in FIG. 1, an elevator system (100) in a building (105) provides for raising and lowering of an elevator car (110) through a hoistway (115). Support structures (120 and 122) support winches (130 and 132), respectively. The winches used in the present embodiment (130 and 132) may be drum-type winch subsystems, as will be discussed below in relation to FIG. 5. However, in alternate embodiments, additional or different winch types or systems may be utilized without departing from the scope of the present disclosure. Support structures (120 and 122) in this embodiment are supported vertically at or near their bases, and they are supported against horizontal movement by attachment to the walls of the hoistway (115) and/or other attachments to portions of the building (105) as will occur to those skilled in the art.

The elevator car (110) is suspended in this embodiment from winches (130 and 132) by flat suspension member sets (140 and 142), respectively. A termination point (144) for the flat suspension member set (140) and a termination point (146) for the flat suspension member set (142) are attached (preferably symmetrically about the car's center of mass, though not necessarily so) to the top of the elevator car (110) to connect the elevator car (110) to the supporting suspension member sets (140 and 142). In the present embodiment of the elevator system, no deflector sheaves are needed.

In this embodiment, the elevator system further comprises a synchronization device (150) having circuitry that takes input from displacement sensors (152, 154, 156 and 158) and differentially drives winches 130 and 132 to keep the elevator car (110) level. In one embodiment, two of the displacement sensors (152 and 154) each measure the distance between the side of the elevator car (110) and the wall of the hoistway (115). If one of the displacement sensors (152) detects that the elevator car (110) is too close to the wall of the hoistway (115), then the synchronization device (150) controls the winch (130) to allow more of the flat suspension member set (140) to be let out (or, equivalently, not to be taken in) relative to operation of the winch (132) on the other flat suspension member set (142). Alternatively or additionally, other displacement sensors (156 and 158) measure the distance from their fixed position to the outermost turn of the flat suspension member set (140 or 142) (respectively), from which it can be inferred how much of the flat suspension member (140 or 142) is hanging between the winch (130 or 132) and the respective termination point (144 or 146). With information regarding the horizontal position of the elevator car (110) in the hoistway (115) and/or the differential height of the termination points (144 and 146), the synchronization device (150) keeps the elevator car (110) properly oriented (e.g., level) both during movement and at rest.

Using additional or alternative sensors, the synchronization device (150) measures the torque exerted by the winches (130 and 132) and/or directly measures the vertical distance between the elevator car (110) and one of the winches (130 and 132) (or another defined point) to obtain information about the position and orientation of the elevator car (110). The synchronization device (150) then differentially operates the winches (130 and 132) to maintain the desired position and orientation of the elevator car (110).

FIG. 2 is a perspective view of the elevator system (100) from FIG. 1. Again, the elevator system (100) comprises drum winches (130 and 132), each holding and operating the flat suspension member (140 and 142), respectively, to control movement of the elevator car (110) between a first-floor position (160) and a second-floor position (162). The support structures (120 and 122) are situated between the sides of the elevator car (110) and the walls of the hoistway (115), supporting the respective winches (130 and 132) at a position near the top of the hoistway (115).

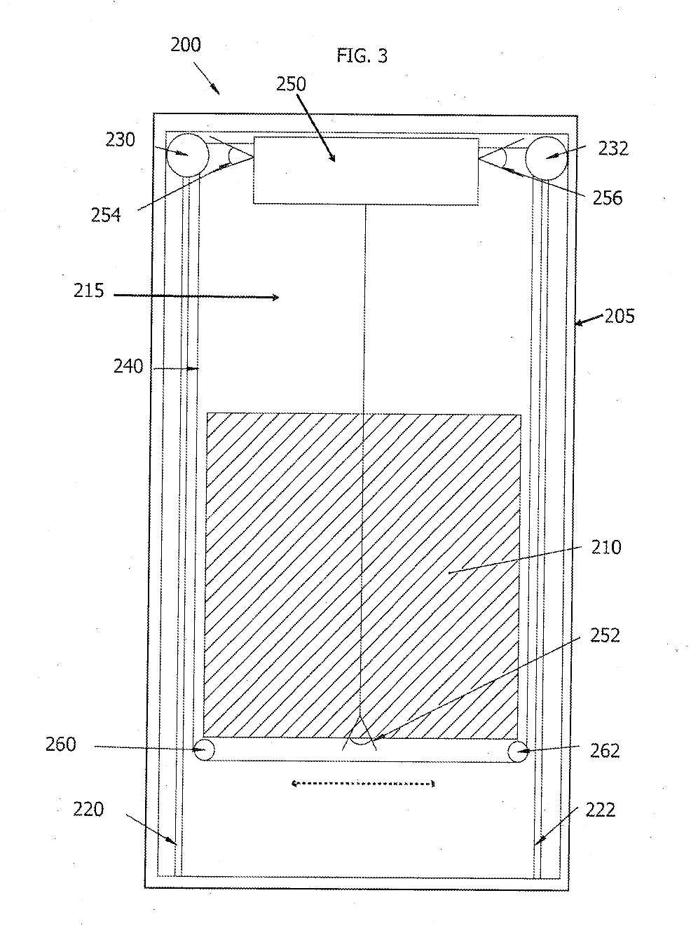

In an alternate embodiment illustrated in FIG. 3, an elevator system (200) includes an elevator car (210), which is raised and lowered through a hoistway (215). In this system, support structures (220 and 222) support drum winches (230 and 232), respectively. The support structures (220 and 222) are again supported in the vertical dimension at and/or near the bottom of each one, and they are supported against horizontal movement along their length by one or more attachments (not shown) to the outside of the hoistway (215) or other structural element of a building (205).

In this exemplary embodiment, a single flat suspension member set (240) runs from one winch (230) down along the side of the elevator car (210), around deflector sheaves (260 and 262) (attached to respective bottom corners of the elevator car (210)), and up along the opposite side of the elevator car (210) to the other winch (232).

The synchronization device (250) takes input from displacement sensors (252, 254, and 256) as inputs into a control circuit that controls the position and orientation of the elevator car (210). In this embodiment, one of the displacement sensors (252) detects the displacement between the flat suspension member set (240) as it runs along the bottom of the elevator car (210) and the bottom of the elevator car (210) itself. Alternatively or additionally, other displacement sensors (254 and 256) may detect the outer diameter of one or both of the drum winches (230 or 232), respectively, including the thickness of the wound portion of the flat suspension member (240) on each drum. When lateral displacement is detected by the displacement sensor (252), or an unexpected differential is detected between the outer diameters of the drum winches (230 and 232) by the displacement sensors (254 and 256), respectively, the synchronization device (250) differentially drives the winches (230 and 232) to correct the misalignment. In alternate embodiments, other position sensing and correction systems may be utilized or incorporated in an elevator system as disclosed herein, without departing from the scope of the present disclosure.

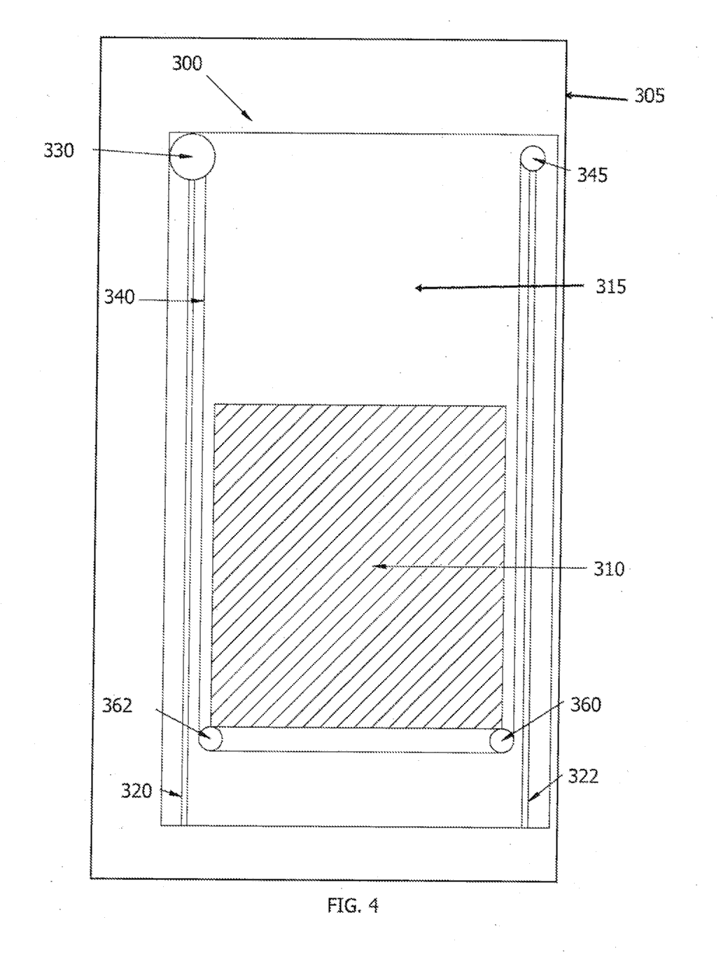

FIG. 4 illustrates a third elevator system (300), which moves an elevator car (310) up and down a hoistway (315) in a building (305). In this exemplary embodiment, a support structure (320) runs along one side of the hoistway (315) to support a winch (330) at or near the top, while another support structure (322) runs along the opposite side of the hoistway (315) to support a suspension member termination point (345). A flat suspension member set (340) ends at the suspension member termination point (345), running down one side of the elevator car (310), around deflector sheaves (360 and 362) disposed on opposite corners of the bottom of the elevator car (310), and up the opposite side of the elevator car (310) to the drum winch (330). The drum winch (330) rotates to take in more or less of the flat suspension member set (340) to raise and lower the elevator car (310). Because the elevator system (300) includes only a single winch in this embodiment, no synchronization between multiple winches is needed.

In some embodiments, the elevator car is a frameless, full-steel, lightweight car made from bent, stamped, or formed sheet metal. The car's outer dimensions are optimized to allow use in small hoistways with the maximum inside dimensions that are permissible under relevant building codes. Of course, alternative embodiments will have different characteristics is these respects.

Turning to FIG. 5, an embodiment of a drum winch (400) is illustrated for use with the disclosed systems. A motor (410) is coupled to a first end of a drum (420) by way of a gear box disposed there between. The motor (410) produces rotational energy to drive gearing or a gear train within the gearbox (430), which in turn drives rotational movement of the drum (420). Disposed at and coupled to an opposite second end of the drum (420) is a brake (440) that includes components and subsystems configured to slow and/or stop rotation of the drum (420), as needed, to manage the speed and position of the associated elevator car. In some embodiments, the brake (440) and a torque limiter (not shown) can be part of the winch subsystem (400). Compared with other types of winches and elevator equipment, drum winches usable in the present embodiments are lightweight and small given particular design parameters, including nominal load, number of stops, and speed.

In various embodiments, the motor (410) is a four- or six-pole synchronous motor with an attached planetary drive that has a reduction factor appropriate for the design criteria. However, the above disclosed embodiment should not be read to limit the type of motor that may be utilized in an elevator system of the present disclosure. In alternate embodiments, additional motors and motor types may be used without departing form the scope of the present disclosure. For example, permanent magnet motors can also be used, either with or without a gear box. Still other alternate embodiments may use regenerative drives.

The brake (440) is, in some embodiments, a one, two, or multi-step step brake. In embodiments in which the operational brake is not part of the winch subsystem (400), the brake may alternatively be mounted on the car and acts on at least one support structure. If the brake is mounted to the car, it may be combined in some embodiments with a safety gear. Each drum uses at least one flat suspension member (450) to support the elevator car. In the illustrated embodiments, the flat suspension members have a thickness of about one (1) millimeter, though suspension members having alternate or differing thicknesses may be utilized without departing from the scope of the present disclosure. In one embodiment, the width of the flat suspension member (450) may be ninety (90) millimeters, while in an alternate embodiment the width may be one hundred twenty (120) millimeters, as described in Table 1, which shows exemplary belt characteristics.

TABLE 1

| Belt Type | A | B |
|---|---|---|
| THICKNESS (mm) | 1 | 1 |
| Width (mm) | 90 | 120 |
| Breaking Strength (KN) | 124.7 | 166.3 |
| Safety Factor | 12 | 12 |

However, in still further alternate embodiments, the flat suspension member may have different characteristics than those disclosed above, without departing from the scope of the present disclosure.

The “profile ratio” of a flat suspension member is defined for the purposes of this description as the proportion between the “width” (i.e., longest dimension) and “thickness” (measured as the greatest thickness measured perpendicular to the width) of a typical cross section of the flat suspension member in the region that is taken up by the drum winch, as the elevator car travels between its lowest and highest extents. So defined, the flat suspension members for use with the present invention may have a profile ratio that is at least about 10:1, though this profile ratio is preferably at least about 50:1. More preferably, the profile ratio is at least about 90:1, and in some embodiments the profile ratio is at least about 120:1.

Of course, the larger the cross section, the more material there is through which to distribute the tension resulting from the weight of the car, but as the thickness of the flat suspension member (450) increases, the diameter of the drum (420) and its windings increases that much for each rotation of the drum (420), and more space must be allocated for the drum (420) and its windings. In addition, as the diameter of the combined drum (420) and windings increases, the torque needed to take up the flat suspension member (450) at a constant linear rate increases, putting more demand on the motor (410).

Exemplary specifications for the drum winch are shown in Table 2. In one embodiment, the diameter of the empty drum (420) is eighty (80) millimeters, and after taking up enough of the flat suspension member (450) to raise the elevator car to the sixth floor, based on the assumptions below, it reaches just one hundred sixty (160) millimeters. For a two-stop elevator system, the drum and windings reach only one hundred one (101) millimeters in diameter in some embodiments, though initial windings needed to terminate the flat suspension member (450) on the winch and the thickness tolerances of the flat suspension member (450) may sometimes yield an outer diameter up to thirty percent (30%) larger than the theoretical thickness shown below.

TABLE 2

| | | Number of Stops | | | | |
|---|---|---|---|---|---|---|
| | | 2 | 3 | 4 | 5 | 6 |
| | | Stop | Stop | Stop | Stop | Stop |
| Distance between | 20 | | | | | |
| Coils (mm) | | | | | | |
| Belt Thickness (mm) | 1 | | | | | |
| Drum Core Diameter (mm) | 80 | | | | | |
| Travel Height (mm) | 0 | 3000 | 6000 | 9000 | 12000 | 15000 |
| Max. Drum Outer | 80 | 101 | 118 | 134 | 147 | 160 |
| Diameter (mm) | | | | | | |

The selection of the planetary gear boxes (430) for use in the embodiments shown in FIGS. 1-3 may be made by those skilled in the art as a function of the number of stops, the speed, and the nominal load of the elevator car. For example, gear boxes manufactured by Loenne as models PG 101 F, PG 161 F, PG 251 F, PG 501 F, PG 701 F, and PG 1001 F have been found satisfactory in various configurations for nominal car speeds of 0.51, 0.76, and 1 m/s.

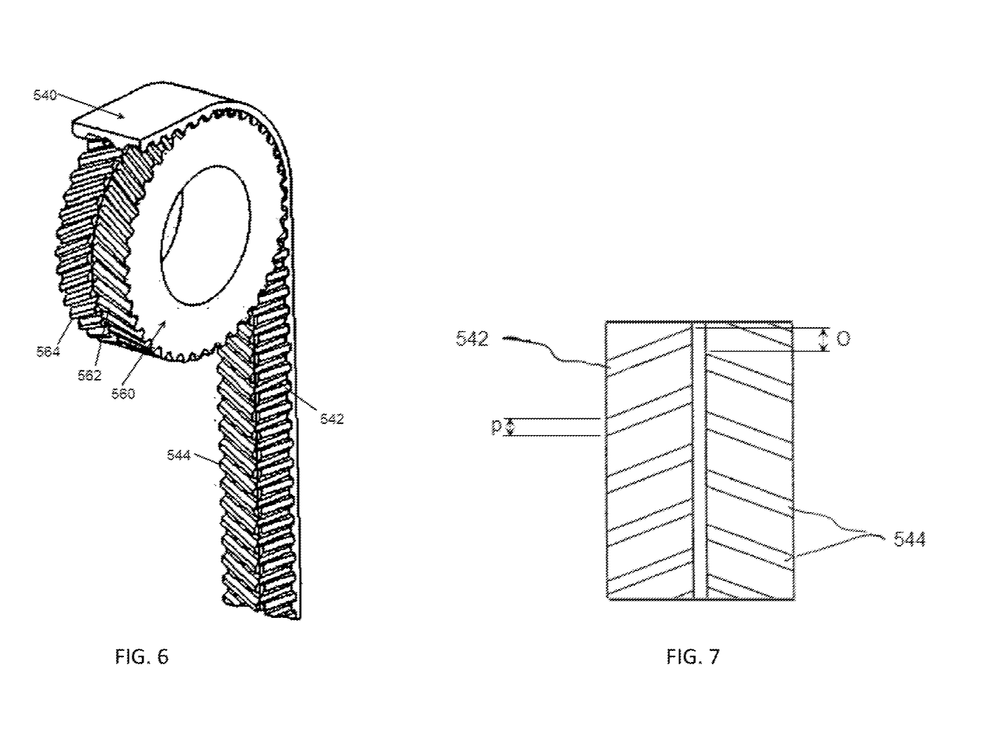

While the previous discussed embodiments have utilized winches and flat suspension members, in still further alternate embodiments of an elevator system of the present disclosure, toothed or cogged suspension members may be used with a complementary toothed or cogged sheave. FIG. 6 shows an embodiment of a toothed suspension member (540) having a first set of teeth (542) disposed along a longitudinal length of the suspension member, on a first lateral half thereof, and oriented at a first angle relative to a longitudinal centerline of the suspension member. The toothed suspension member further includes a second set of adjacent teeth (544) disposed along the longitudinal length of the suspension member on a second half thereof, and which teeth are oriented at a second angle, adjacent and equal to the first angle, with respect to the common longitudinal centerline of the suspension member. In this manner, the first set of teeth (542) and the second set of teeth (544) together form a herringbone pattern. In one embodiment, the first and second sets of teeth may be a mirror image of each other about the longitudinal centerline of the suspension member, while in alternate embodiments, the first set of teeth and second set of teeth may be mirror images that are offset from each other in the longitudinal direction by a defined offset distance. In the embodiment illustrated in FIG. 7, any two consecutive teeth in the longitudinal direction of the suspension member, in either of the first or second set of teeth (542, 544), are separated by a predefined distance, or pitch (p). In addition, each tooth in the first set of teeth (542) is offset in the longitudinal direction of the suspension member, relative to each laterally adjacent tooth in the second set of teeth (544), by an offset distance (o). In still further alternate embodiments, the first set of teeth (542) can have a different pitch than the second set of teeth (544) and/or the first and second sets of teeth (542 and 544) can be aligned such that the offset distance (o) is substantially zero. Another example of a toothed suspension member is disclosed in U.S. Pat. No. 5,209,705, entitled “Synchronous Drive Belt With Oblique and Offset Teeth,” filed on May 29, 1992, the disclosure of which is incorporated by reference herein.

Referring back to FIG. 6, the first and second sets of teeth (542 and 544) disposed on the toothed suspension member (540) correspond to complimentary teeth (562 and 564) disposed on a sheave (560), such as a drive sheave, deflector sheave, or other such sheaves, used in elevator systems disclosed herein. In this manner, the first and second sets of teeth (542 and 544) on the suspension member engage with spaces defined between the teeth (562 and 564) of the sheave (560). The herringbone tooth pattern on the toothed suspension member engaging or mating with the corresponding herringbone tooth pattern on the sheave, allows the toothed suspension member (540) to self-center on the sheave (560). The force transmission between the sheave (560) and the toothed suspension member (540) is based on positive locking between the first and second sets of teeth (542 and 544) on the toothed suspension member (540) and the corresponding teeth (562 and 564) disposed on the sheave (560). This can produce a high traction to enable elevator systems without counterweights. However, in various embodiments, counterweights may also be utilized to offset or partially balance out the weight of the elevator cab on the elevator system, without departing from the scope of the present disclosure.

The toothed suspension member (540) is formed from polyurethane or other suitable materials. In one embodiment, the toothed suspension member (540) comprises a surface coating of polyamide on the toothed side of the toothed suspension member (540), which can improve wear and/or reduce noise of the toothed suspension member (540). The toothed suspension member (540) further includes at least one load carrier, which can be formed from materials such as carbon, aramid fibers, steel cords, etc. In the illustrated embodiments, the toothed suspension members have a thickness of about 8.64 millimeters; though suspension members having alternate or differing thicknesses may be utilized without departing from the scope of the present disclosure. The width of the toothed suspension members may be between about 30 and about 200 mm, such as, e.g. about 52 millimeters. Table 3 shows exemplary toothed belt characteristics.

TABLE 3

| Belt Type | Toothed |
|---|---|
| THICKNESS (mm) | 8.64 |
| Width (mm) | 52 |
| Pitch (mm) | 10 |
| Weight (kg/m) | 0.425 |
| Breaking Strength (KN) | 290 |
| Hardness (Shore A) | 92-95 |
| Safety Factor | 12 |

However, in still further alternate embodiments, the toothed suspension member may have different characteristics than those disclosed above, without departing from the scope of the present disclosure.

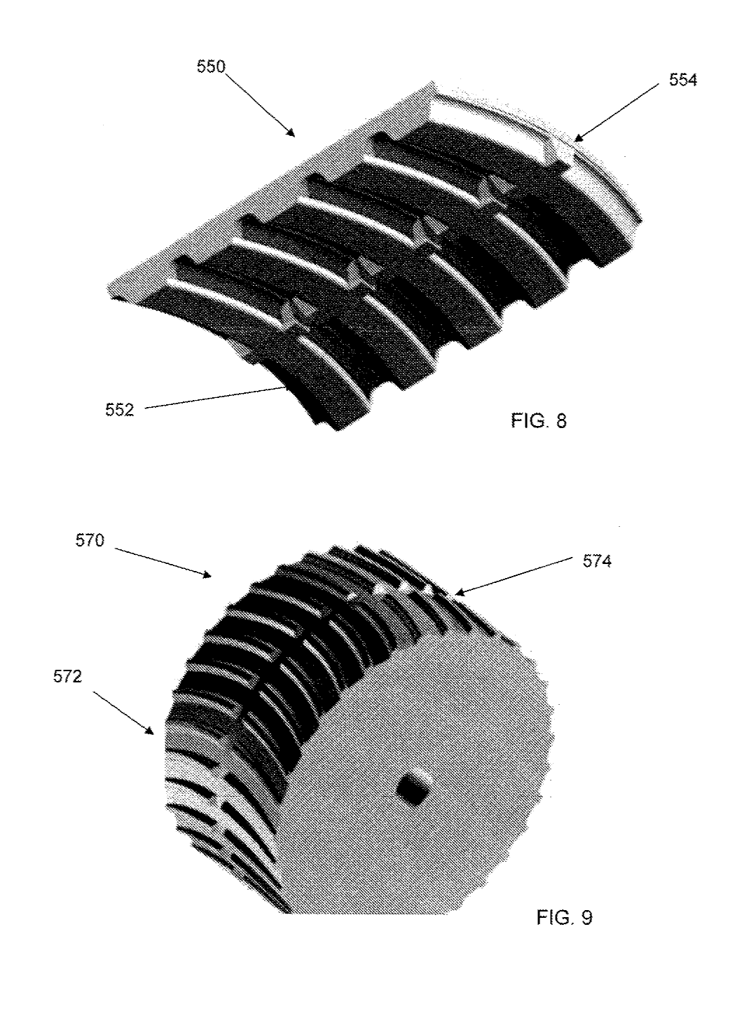

FIG. 8 shows still another alternate embodiment of a toothed suspension member (550) having a curved set of teeth (552). Each tooth in the curved set of teeth (552) comprises a rib (554) extending transversely relative to the teeth (552) from each side of the tooth at a central portion of the tooth. This tooth configuration of a toothed suspension member (550) corresponds to a complimentary sheave (570), shown in FIG. 9. The sheave (570) comprises curved teeth (572) and an annular groove (574) formed in a central portion of the sheave (570). Accordingly, the curved set of teeth (552) of the toothed suspension member (550) engages with spaces defined between the teeth (572) of the sheave (570), and the ribs (554) of the toothed suspension member (550) engage with the annular groove (574) of the sheave (570). This allows the toothed suspension member (550) to self-center on the sheave (570).

The toothed suspension member (550) is formed from polyurethane or other suitable materials. In the present embodiment, the toothed suspension member (550) comprises a surface coating of polyamide on the toothed side of the toothed suspension member (550), which can improve wear and/or reduce noise of the toothed suspension member (550). The toothed suspension member (550) further includes at least one load carrier, which can be formed from materials such as carbon, aramid fibers, steel cords, or other suitable materials capable of carrying an active load. The toothed suspension member (550) may have a width of about 100 mm and a breaking load of about 150 KN. Of course, other configurations of the toothed suspension members (550) will occur to those skilled in the art in view of the present disclosure.

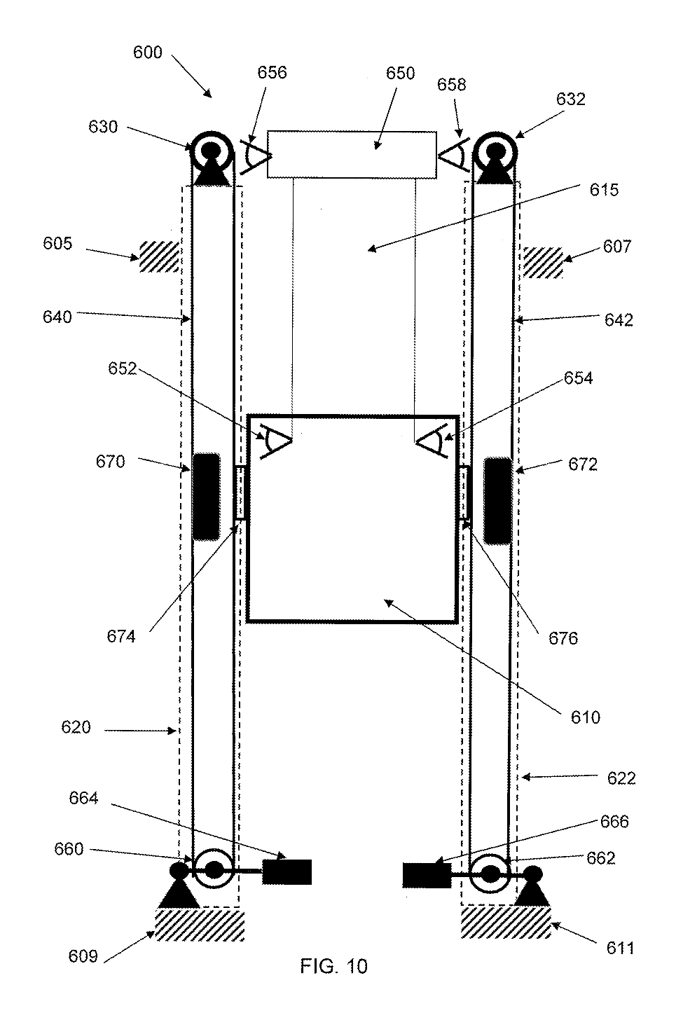

Such flat suspension members (140, 142, 240, 340, 450) and/or toothed suspension members (540, 550) can be used in the illustrated elevator systems. For instance, FIG. 10 shows an alternative elevator system (600) that includes an elevator car (610), which is raised and lowered through a hoistway (615). In this system, support structures (620 and 622) support first and second drive sheaves (630 and 632), respectively. The support structures (620 and 622) are again supported in the vertical dimension at and/or near the bottom of each one by building attachments (609 and 611), and they are also supported against horizontal movement along their length by one or more building attachments (605 and 607).

In this exemplary embodiment, the elevator system (600) comprises two closed loop belt systems. A first toothed suspension member set (640) runs from a first drive sheave (630) down along the side of the elevator car (610), around a deflector sheave (660), and back up to the first drive sheave (630). A second toothed suspension member set (642) runs from the second drive sheave (632) down along an opposing side of the elevator car (610), around a deflector sheave (662), and back up to the second drive sheave (632). The toothed suspension member sets (640 and 642) have a substantially equal length. One of the toothed suspension member sets (640) is attached to the first side of the elevator car (610) via a connection unit (674) and the other toothed suspension member set (642) is attached to the opposing side of the elevator car (610) via another connection unit (676). The connection units (674 and 676) are coupled to the elevator car (610) at substantially equal heights to level the elevator car (610). Because the elevator system (600) does not require deflector sheaves to be positioned on the elevator car (610), the size and mass of the elevator car (610) can be reduced to allow for smaller hoistway dimensions, reduced motor sizes, and increased energy efficiency.

FIG. 10 shows tensioning weights (664 and 666) coupled to each respective toothed suspension member set (640 and 642) near the respective deflector sheaves (660 and 662). Each of the toothed suspension member sets (640 and 642) can further include an optional counterweight (670 and 672), respectively. Such counterweights (670 and 672) balance the empty elevator car (610) weight and part of the nominal load.

Accordingly, when each drive sheave (630 and 632) is activated, the toothed suspension member sets (640 and 642) rotate simultaneously in opposing directions. Because each toothed suspension member set (640 and 642) is fixed to the elevator car (610) via the connection units (674 and 676), the rotation of the toothed suspension member sets (640 and 642) thereby raises and/or lowers the elevator car (610). A synchronization device (650) includes circuitry that takes input from displacement sensors (652, 654, 656 and 658) and differentially drives the drive sheaves (630 and 632) to keep the elevator car (610) level. As will be discussed further below, the synchronization device (650) obtains information about the position and orientation of the elevator car (610) and then differentially operates the drive sheaves (630 and 632) to maintain the desired position and orientation of the elevator car (610). In some embodiments, when lateral displacement is detected by certain displacement sensors (652 and 654), or an unexpected differential is detected between the drive sheaves (630 and 632) by certain other displacement sensors (656 and 658), respectively, the synchronization device (650) differentially drives the drive sheaves (630 and 632) to correct the misalignment. For instance, displacement sensors (656 and 658) may monitor the position of the rotary movement of the motor shaft (e.g., an encoder), or the traction sheave (e.g., a sheave teeth counter), or the longitudinal position of the belt (e.g., a belt teeth counter or a bar code reader). Of course, other position sensing and correction systems may be used herein without departing from the scope of the present disclosure.

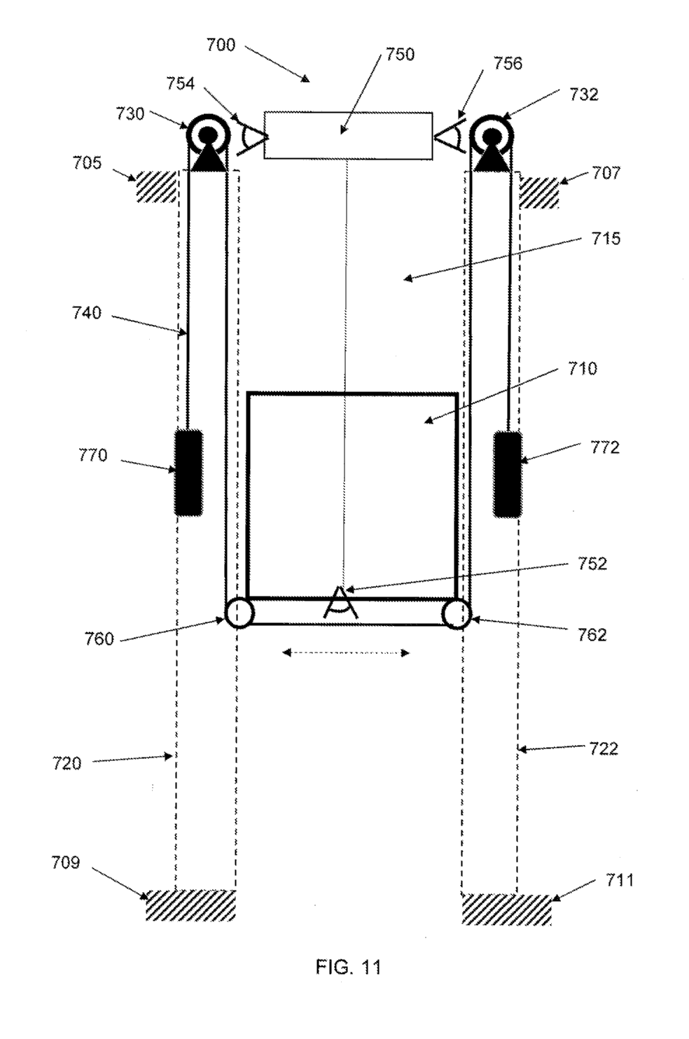

In an alternative embodiment, shown in FIG. 11, an elevator system (700) comprises an elevator car (710), which is raised and lowered through a hoistway (715). In this system, support structures (720 and 722) support first and second drive sheaves (730 and 732), respectively. The support structures (720 and 722) are again supported in the vertical dimension at and/or near the bottom of each one at building attachments (709 and 711), and they are supported against horizontal movement along their length by one or more building attachments (705 and 707) to the outside of the hoistway (715).

The elevator system (700) comprises a single open loop belt system. A single toothed suspension member set (740) runs from the first drive sheave (730) down along the side of the elevator car (710), around deflector sheaves (760 and 762) that are attached to respective bottom corners of the elevator car (710), and up along the opposite side of the elevator car (710) to the second drive sheave (732). A first tensioning weight (770) is coupled to a first end of the toothed suspension member set (740) and a second tensioning weight (772) is coupled to the opposing end of the toothed suspension member set (740). Accordingly, the tensioning weights (770 and 772) move with the elevator car (710), in the opposing direction, to balance the mass of the elevator car (710). The mass of the tensioning weights (770 and 772) can prevent the toothed suspension member set (740) from slipping on the drive sheaves (730 and 732) and/or on the deflector sheaves (760 and 762). The elevator system (700) eliminates the need for equipment positioned in the bottom portion of the hoistway (715) to improve the safety of performing maintenance on the elevator system (700) and to prevent damage of the elevator system (700) from flooding.

A synchronization device (750) takes input from displacement sensors (752, 754, and 756) as inputs into a control circuit that controls the position and orientation of the elevator car (710). In this embodiment, one of the displacement sensors (752) detects the displacement between the toothed suspension member set (740) and the bottom of the elevator car (710) as the toothed suspension member set (740) runs along the bottom of the elevator car (710). In an alternate embodiment, a bar code or other form of marking on the belt (e.g., magnetic or optical) could be used. Alternatively or additionally, an unexpected differential is detected between the drive sheaves (730, 732) by other displacement sensors (754 and 756). Each of the other displacement sensors (754, 756) may comprise an encoder, a sheave teeth counter, a belt teeth counter, or a bar code reader. When lateral displacement is detected by the displacement sensor (752), or an unexpected differential is detected between the drive sheaves (730 and 732) by the displacement sensors (754 and 756), respectively, the synchronization device (750) controls the activation and/or speed of the motors that drive the drive sheaves (730 and 732) to correct the misalignment. The synchronization device (750) thereby effectuates the alignment of the tensioning weights (770 and 772) to the same height. Of course, other position sensing and correction systems may be used as will occur to those having ordinary skill in the art.

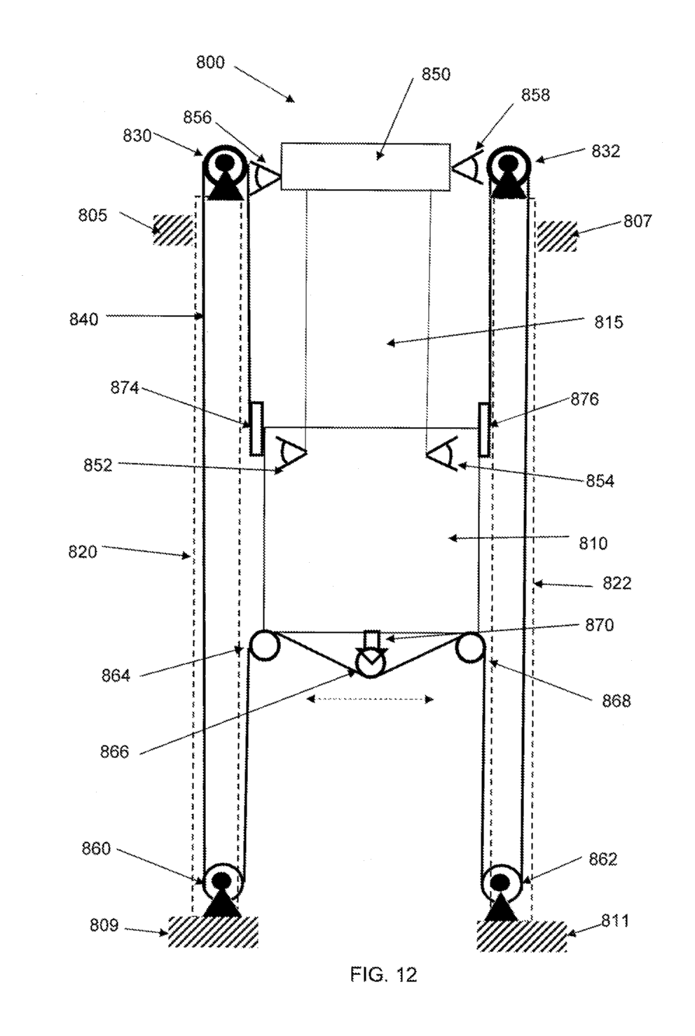

FIG. 12 shows another alternate embodiment of an elevator system (800) that includes an elevator car (810), which is raised and lowered through a hoistway (815). In this system, support structures (820 and 822) support first and second drive sheaves (830 and 832), respectively. The support structures (820 and 822) are again supported in the vertical dimension at and/or near the bottom of each one by building attachments (809 and 811), and they are also supported against horizontal movement along their length by one or more building attachments (805 and 807).

In this exemplary embodiment, the elevator system (800) comprises a single closed loop belt system. A first end of a toothed suspension member (840) is coupled to a first side of the elevator car (810) via a connection unit (874). From the connection unit (874), the toothed suspension member (840) runs up around a first drive sheave (830) and down around a deflector sheave (860), which is coupled to one of the building attachments (809). The toothed suspension member (840) then travels through other deflector sheaves (864, 866, and 868) positioned on the bottom portion of the elevator car (810). As shown in FIG. 12, the toothed suspension member (840) passes above the deflector sheave (864) positioned on the first side of the elevator car (810), below the deflector sheave (866) positioned centrally on the elevator car (810), and above the deflector sheave (868) positioned on the opposing side of the elevator car (810). The toothed suspension member (840) then runs down around another deflector sheave (862) coupled to the building attachment (811) and up to a second drive sheave (832). The second end of toothed suspension member (840) is then coupled to the opposing side of the elevator car (810) via a connection unit (876). The connection units (874 and 876) are coupled to the elevator car (810) at substantially the same height to level the elevator car (810).

A belt tensioner (870) is coupled to the bottom of the elevator car (810) in the present embodiment between the elevator car (810) and the central deflector sheave (866). The belt tensioner (870) is operable to maintain a desired pre-tension on both of the drive sheaves (830 and 832). A counterweight can optionally be provided on each side of the elevator car (810) on the toothed suspension member (840).

Accordingly, the drive sheaves (830 and 832) can be actuated to rotate in opposing directions to rotate the toothed belt suspension member set (840), which thereby raises and/or lowers the elevator car (810). A synchronization device (850) includes circuitry that takes input from the displacement sensors (852, 854, 856 and 858) and controls the activation and/or speed of the motors that drive the drive sheaves (830 and 832) to keep the elevator car (810) level. As will be discussed further below, the synchronization device (850) obtains information about the position and orientation of the elevator car (810), and then differentially controls the drive sheaves (830 and 832) to maintain the desired position and orientation of the elevator car (810). In one embodiment, when lateral displacement is detected by certain displacement sensors (852 and 854), the synchronization device (850) differentially controls the activation and/or speed of the motors that drive the drive sheaves (830 and 832) to correct the misalignment. Of course, other position sensing and correction systems may be used as will occur to those having ordinary skill in the art.

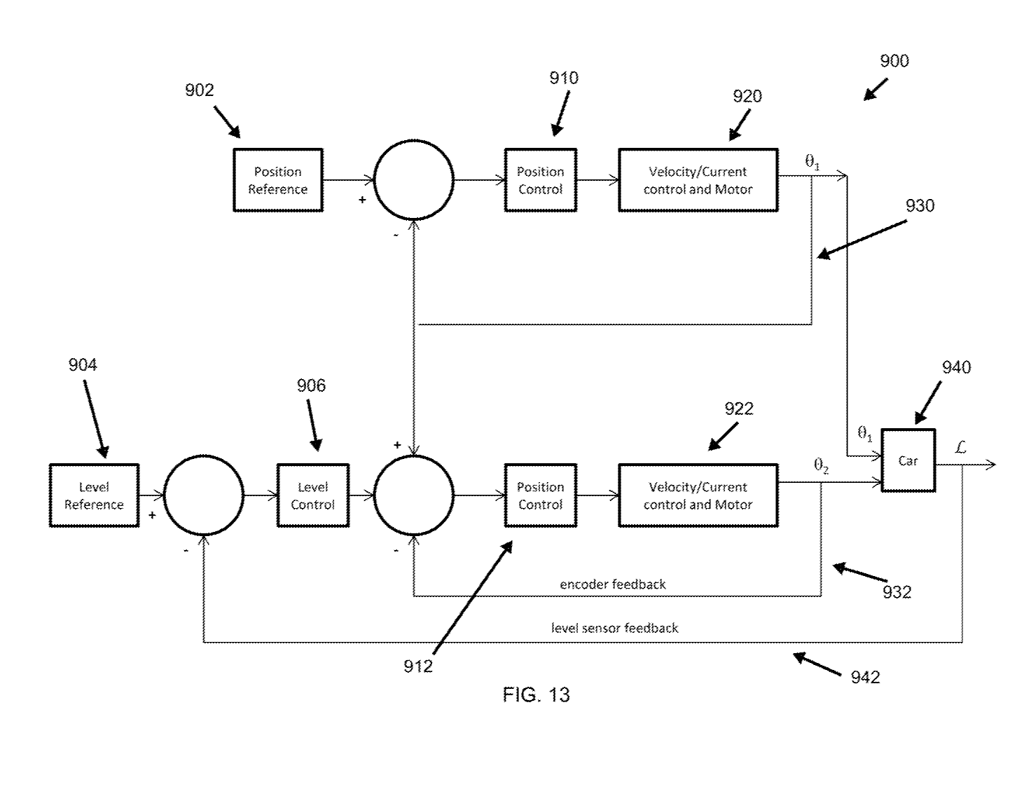

FIG. 13 shows a synchronization control (900) that can be used by the synchronization devices (150, 250, 650, 750, 850) to maintain the alignment of the elevator cars (110, 210, 610, 710, 810, 940). In the present embodiment, the synchronization control (900) receives a position reference (902) to set a target position for the first winch/drive sheave (130, 230, 630, 730, 830) of the elevator system (100, 200, 600, 700, 800). The actual position θ₁ of the first winch or drive sheave (130, 230, 630, 730, 830) is detected by a sensor, such as an encoder or the displacement sensors (156, 254, 656, 754, 856). This sensor feedback (930) is then compared with the position reference (902). A position control (910) receives this comparison to determine whether to move the first winch or drive sheave (130, 230, 630, 730, 830). For instance, if the actual position θ₁ of the first winch or drive sheave (130, 230, 630, 730, 830) is the same or substantially equal to the position reference (902), the position control (910) may determine not to move the first winch or drive sheave (130, 230, 630, 730, 830). Alternatively, if the actual position θ₁ of the first winch or drive sheave (130, 230, 630, 730, 830) is offset from the position reference (902), the position control (910) may determine the distance and direction to move the first winch or drive sheave (130, 230, 630, 730, 830) so that the actual position θ₁ of the first winch or drive sheave (130, 230, 630, 730, 830) is the same or substantially equal to the position reference (902). The distance determined by the position control (910) to move the first winch or drive sheave (130, 230, 630, 730, 830) is then sent from the position control (910) to a velocity/current control (920) to convert the determined distance into a current to actuate the first winch or drive sheave (130, 230, 630, 730, 830) to move the determined distance. When actuated, the first winch or drive sheave (130, 230, 630, 730, 830) thereby moves the corresponding side of the elevator car (110, 210, 610, 710, 810, 940) the determined distance to raise and/or lower the elevator car (110, 210, 610, 710, 810, 940) to the target position.

The second winch or drive sheave (132, 232, 632, 732, 832) is also actuated by the synchronization control (900) to move the opposing side of the elevator car (110, 210, 610, 710, 810, 940) to keep the elevator car (110, 210, 610, 710, 810, 940) level. The synchronization control (900) receives a level reference (904), which may be set to zero such that there is substantially no offset between the position of the first winch or drive sheave (130, 230, 630, 730, 830) and the second winch or drive sheave (132, 232, 632, 732, 832). This level reference (904) is then compared with the actual level [symbol] of the elevator car (110, 210, 610, 710, 810, 940), which can be determined by a level sensor such as a gyroscope or the displacement sensors (152, 154, 252, 652, 654, 752, 852, 854) to provide a level sensor feedback (942). This comparison is received by a level control (906) to determine the level of the elevator car (110, 210, 610, 710, 810, 940). For instance, if the actual level [symbol] of the elevator car (110, 210, 610, 710, 810, 940) is the same or substantially equal to the level reference (904), the level control (906) may determine not to move the second winch or drive sheave (132, 232, 632, 732, 832) relative to the first winch or drive sheave (130, 230, 630, 730, 830). Alternatively, if the actual level [symbol] of the elevator car (110, 210, 610, 710, 810, 940) is offset relative to the level reference (904), the level control (906) may determine the distance and direction to move the second winch or drive sheave (132, 232, 632, 732, 832) relative to the first winch or drive sheave (130, 230, 630, 730, 830) so that the actual level [symbol] of the elevator car (110, 210, 610, 710, 810, 940) is the same or substantially equal to the level reference (904).

The distance determined by the level control (906) is then compared with the actual position θ₁ of the first winch or drive sheave (130, 230, 630, 730, 830) and the actual position θ₂ of the second winch or drive sheave (132, 232, 632, 732, 832). The actual position θ₂ of the second winch or drive sheave (132, 232, 632, 732, 832) is detected by a sensor, such as an encoder or the displacement sensors (158, 256, 658, 756, 858). A position control (912) for the second winch or drive sheave (132, 232, 632, 732, 832) receives the comparison from the level control (906), the sensor feedback (930) from the first winch or drive sheave (130, 230, 630, 730, 830), and a sensor feedback (932) from the second winch or drive sheave (132, 232, 632, 732, 832).

The position control (912) then determines whether to move the second winch or drive sheave (132, 232, 632, 732, 832). For instance, if the actual position θ₂ of the second winch or drive sheave (132, 232, 632, 732, 832) is the same or substantially equal to the actual position θ₁ of the first winch or drive sheave (130, 230, 630, 730, 830) and the elevator car (110, 210, 610, 710, 810, 940) is substantially level, the position control (912) may determine not to move second the second winch or drive sheave (132, 232, 632, 732, 832). Alternatively, if the actual position θ₂ of the second winch or drive sheave (132, 232, 632, 732, 832) is offset from the actual position θ₁ of the first winch or drive sheave (130, 230, 630, 730, 830) or the elevator car (110, 210, 610, 710, 810, 940) is not level, the position control (912) may determine the distance and direction to move the second winch or drive sheave (132, 232, 632, 732, 832) so that the actual position θ₂ of the second winch or drive sheave (132, 232, 632, 732, 832) is the same or substantially equal to the actual position θ₁ of the first winch or drive sheave (130, 230, 630, 730, 830) and/or to level the elevator car (110, 210, 610, 710, 810, 940). The distance determined by the position control (912) to move the second winch or drive sheave (132, 232, 632, 732, 832) is then sent to a velocity/current control (922) to convert the determined distance into a current to actuate the second winch or drive sheave (132, 232, 632, 732, 832) to move the determined distance. When actuated, the second winch or drive sheave (132, 232, 632, 732, 832) thereby moves the opposing side of the elevator car (110, 210, 610, 710, 810, 940) the determined distance to raise and/or lower the elevator car (110, 210, 610, 710, 810, 940) to the target position.

The synchronization control (900) can have a steady-state position error between the position of the first winch or drive sheave (130, 230, 630, 730, 830) and the second winch or drive sheave (132, 232, 632, 732, 832) of about zero, and a transient position error between the position of the first winch (130, 230, 630, 730, 830) and the second winch or drive sheave (132, 232, 632, 732, 832) of less than about 5 degrees of rotation. Other position sensing and correction systems may be used as will occur to those having ordinary skill in the art. For instance, other suitable positioning sensing and correction systems may be open loop such that the sensor feedbacks (930, 932, 942) are optional.

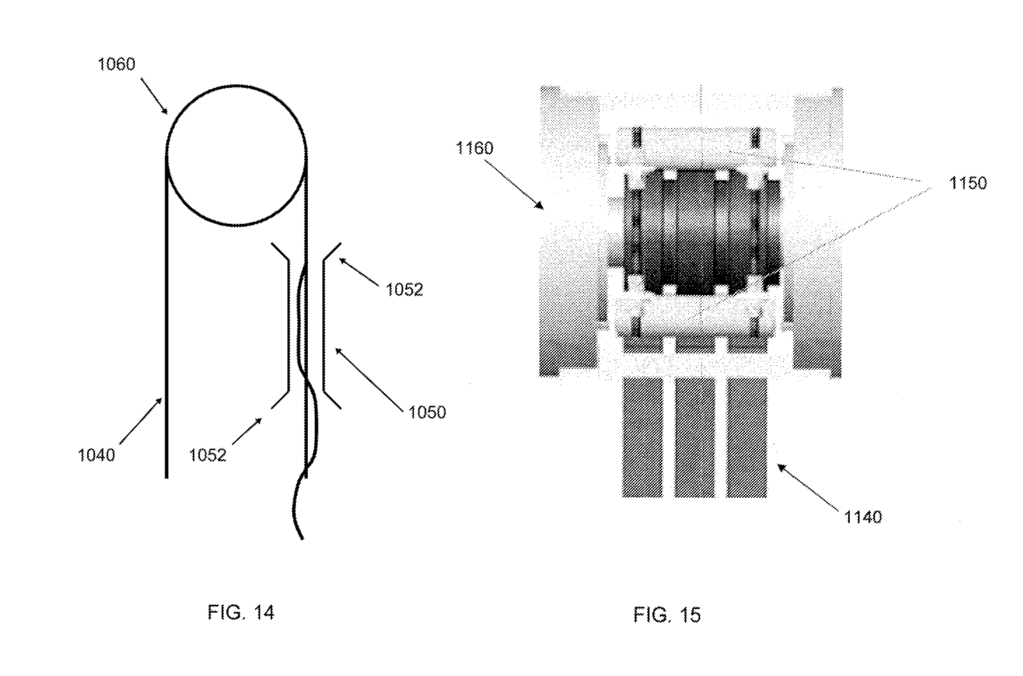

FIG. 14 shows an embodiment of a wave protector (1050). In some instances, a suspension member (1040) may develop waves, which may cause the suspension member (1040) to jump or become misaligned with a winch or drive sheave or a deflector sheave (1060). For instance, the suspension member (1040) may have a high-loaded region on the side coupled with an elevator car and a low-loaded region on the opposing side of the winch or drive sheave or the deflector sheave (1060). The low-loaded region of the suspension member (1040) may thereby develop waves, such as during emergency stops. Accordingly, FIG. 14 shows a wave protector (1050) positioned around the low-loaded side of the suspension member (1040) adjacent to the winch or the sheave (1060) to straighten and/or align the suspension member (1040) with the winch or the sheave (1060). The wave protector (1050) thereby dampens waves within the suspension member (1040) near the winch or the deflector sheave (1060). In the present embodiment, the wave protector (1050) further includes ramped surfaces (1052) on each end of the wave protector (1050) to receive the suspension member (1040). Other aligning devices may be used without departing from the scope of the present disclosure.

Alternatively or additionally, suspension member retainers (1150) can be used to protect against jumping of the suspension member (1140), as shown in FIG. 15. In the present embodiment, the retainers (1150) comprise at least one tube positioned on or near the suspension member (1140) adjacent to the winch or the sheave (1160). The retainers (1150) are thereby positioned to hold the suspension member (1140) in alignment against the winch or the sheave (1160) and/or prevent the suspension member (1140) from jumping or pulling away from the winch or the sheave (1160). In some versions, the retainers (1150) are coupled to the winch or the sheave (1160) by resilient members (not shown), such as springs, to allow some movement between the suspension member (1140) and the winch or the sheave (1160). For instance, such resilient members can allow the retainers (1150) to move slightly away from the winch or sheave (1160) to thereby allow the suspension member (1140) to move slightly away from the winch or the sheave (1160), which may prevent damage to the suspension member (1140), such as during an emergency stop. The resilient members are then biased to return the retainers (1150) and the suspension member (1140) towards the winch or the sheave (1160) and into alignment.

While the various embodiments have been illustrated as using a specific number of sheaves, it should be understood that the number and placement of sheaves could be different, as will be understood by those having ordinary skill in the art. For example, though certain embodiments have been shown using two sheaves placed on the bottom of the elevator car, other embodiments may use three sheaves, one sheave, or none at all, and some or all of them might be placed on the top of the elevator car. While the various embodiments have been illustrated as mounting the sheaves to support structures, other embodiments may mount the sheaves to other components of the elevator system, such as the hoistway ceiling, wall, or a machine frame.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

What is claimed is:

1. An elevator system in a hoistway in a building, comprising:
an elevator car;
a first drive sheave;
a second drive sheave; and
at least one suspension member set coupling the first drive sheave to a first side of the elevator car and the second drive sheave to a second, opposing side of the elevator car, wherein the at least one suspension member set comprises at least one toothed suspension member;
wherein the first and second drive sheaves are operable to rotate in opposing directions to move the elevator car within the hoistway.

2. The elevator system of claim 1, wherein the toothed suspension member comprises a first set of teeth oriented at a first angle relative to a longitudinal centerline and a second set of teeth oriented at a second angle, adjacent to the first angle, relative to the longitudinal centerline.

3. The elevator system of claim 2, wherein the second set of teeth is offset relative to the first set of teeth.

4. The elevator system of claim 1 further comprising a synchronization device in communication with the first and second drive sheaves, wherein the synchronization device is operable to level the elevator car.

5. The elevator system of claim 4 further comprising at least one displacement sensor in communication with the synchronization device, wherein the at least one displacement is operable to detect the orientation of the elevator car.

6. The elevator system of claim 5, wherein the at least one displacement sensor is coupled with the elevator car to determine the lateral displacement of the elevator car.

7. The elevator system of claim 5, wherein the at least one displacement sensor is operable to determine a discrepancy between a first longitudinal position of the at least one suspension member set positioned on the first drive sheave and a second longitudinal position of the at least one suspension member set positioned on the second drive sheave.

8. The elevator system of claim 1 further comprising two vertically extending support structures, wherein each of the first and the second drive sheaves are supported by a select one of the support structures.

9. The elevator system of claim 1, wherein the at least one suspension member set is coupled to the elevator car via a connection unit.

10. The elevator system of claim 1 comprising a dual closed loop belt system, wherein the dual closed loop belt system comprises:
a first continuous suspension member set running along a length of the hoistway, wherein the first suspension member set wraps at least partially around the first drive sheave and a first deflector sheave, wherein the first suspension member set is coupled to the first side of the elevator car, and
a second continuous suspension member set running along a length of the hoistway, wherein the second suspension member set wraps at least partially around the second drive sheave and a second deflector sheave, wherein the second suspension member set is coupled to the second side of elevator car.

11. The elevator system of claim 10, wherein the first and second suspension member sets have a substantially equal length.

12. The elevator system of claim 10, further comprising at least one tensioning weight coupled to each one of the first and second suspension member sets.

13. The elevator system of claim 12, further comprising at least one counterweight coupled to each one of the first and second suspension member sets.

14. The elevator system of claim 1 comprising a single open loop belt system, wherein the single open loop belt system comprises:
a first tensioning weight positioned at a first end of the suspension member set,
a second tensioning weight positioned at a second end of the suspension member set, and
at least one deflector sheave positioned on the elevator car,
wherein the suspension member set is positioned around the first drive sheave, the at least one deflector sheave, and the second drive sheave.

15. The elevator system of claim 1 comprising a single loop belt system, wherein the single closed loop belt system comprises:
a first and second deflector sheave positioned in the hoistway; and
at least one deflector sheave positioned on the elevator car,
wherein a first end of the suspension member set is coupled to the first side of the elevator car, wherein the suspension member set wraps around the first drive sheave, around the deflector sheaves, and around the second drive sheave, wherein a second end of the suspension member set is coupled to the second side of the elevator car.

16. The elevator system of claim 15 further comprising a belt tensioner positioned between the first and second drive sheaves.

17. An elevator system in a hoistway in a building, comprising:
an elevator car;
a first drive sheave operable to translate the elevator car;
a second drive sheave operable to translate the elevator car;
at least one suspension member set coupling the first and second drive sheaves to the elevator car; and
a synchronization device operable to actuate the first and second drive sheaves to level the elevator car.

18. An elevator system in a hoistway in a building, comprising:
a first and second support structure extending along a length of the hoistway;
a first and second drive sheave, each positioned at a respective first end portion of each support structure;
a first and second deflector sheave, each positioned at a respective second end portion of each support structure;
a first suspension member set wrapping around the first drive sheave and the first deflector sheave;
a second suspension member set wrapping around the second drive sheave and the second deflector sheave; and
an elevator car, wherein a first side of the elevator car is coupled with the first suspension member set, wherein a second, opposing side of the elevator car is coupled with the second suspension member set;
wherein the first and second drive sheaves are operable to rotate the first and second suspension member sets in opposing directions to thereby translate the elevator car within the hoistway; and
a synchronization device operable to actuate the first and second drive sheaves to level the elevator car.
